(19) United States
(12) Patent Application Publication
(10) Pub. No.: US 2017/0149093 A1
(43) Pub. Date: May 25, 2017

(54) CONFIGURATIONS OF SOLID STATE THIN FILM BATTERIES

(71) Applicant: Applied Materials, Inc., Santa Clara, CA (US)

(72) Inventors: Lizhong Sun, San Jose, CA (US); Byung-Sung Leo Kwak, Portland, OR (US); Miaojun Wang, Santa Clara, CA (US); Dimitrios Argyris, Los Altos, CA (US); Daoying Song, San Jose, CA (US)

(21) Appl. No.: 15/389,050

(22) Filed: Dec. 22, 2016

Related U.S. Application Data
(63) Continuation-in-part of application No. PCT/US2016/052946, filed on Sep. 21, 2016.
Application No. PCT/US2016/052946 is a continuation-in-part of application No. PCT/US2016/053536, filed on Sep. 23, 2016.
(60) Provisional application No. 62/221,573, filed on Sep. 21, 2015.
(60) Provisional application No. 62/222,574, filed on Sep. 23, 2015.
(60) Provisional application No. 62/341,576, filed on May 25, 2016.

(51) Int. Cl. H01M 10/0585; H01M 10/0562; H01M 10/42; H01M 10/04

(52) U.S. Cl. CPC H01M 10/0585; H01M 10/0436; H01M 10/0562; H01M 10/4235; H01M 2220/30

(57) ABSTRACT

A solid state thin film battery may comprise: an adhesion promotion and intermixing barrier layer on a substrate, the layer comprising an electrically insulating material having a thickness in the range of 50 nm to 5,000 nm; a metal adhesion layer on the adhesion promotion and intermixing barrier layer; a current collector layer on the metal adhesion layer; a cathode layer on the current collector layer; an electrolyte layer on the cathode layer; and an anode layer on the electrolyte layer; wherein the device layers form a stack on the thin substrate; and wherein the adhesion promotion layer prevents cracking of the stack and delamination from the thin substrate of the stack during fabrication of the stack, including annealing of the cathode at a temperature in the range of 500° C. to 800° C., and/or intermixing of the current collector and cathode layers during annealing of the cathode layer.

### CROSS-REFERENCE TO RELATED APPLICATIONS

This application is a continuation-in-part of application no. PCT/US2016/52946, filed on Sep. 21, 2016 which claims the benefit of U.S. Provisional Application No. 62/221,573 filed on Sep. 21, 2015, a continuation-in-part of application no. PCT/US2016/53536, filed on Sep. 23, 2016 which claims the benefit of U.S. Provisional Application No. 62/222,574 filed on Sep. 23, 2015, and claims the benefit of U.S. Provisional Application No. 62/341,576 filed on May 25, 2016, all of which are incorporated by reference in their entirety herein.

### FIELD

Embodiments of the present disclosure relate generally to solid state thin film batteries and methods of making the same, and more specifically, although not exclusively, to thin film batteries with an adhesion promotion/intermixing barrier layer deposited on the substrate—between the substrate and adhesion and current collector layers—and an interlayer for reducing the resistance and over-potential at the interfaces with an electrode and a solid state electrolyte.

### BACKGROUND

Thin film batteries (TFBs) may comprise a thin film stack of layers including anode and cathode current collectors (ACC, CCC), a cathode (positive electrode), a solid state electrolyte, an anode (negative electrode) and encapsulation layers or packaging. TFBs may be single-sided or double-sided.

During the fabrication process of thin film batteries, one of the layers, the positive electrode (referred to herein as the cathode), typically formed of a material such as lithium cobalt oxide (LCO) which needs to be annealed, at relatively high temperature, to form an electrode with desirable materials properties—such as having a high percentage (greater than 90%) of high temperature phase LiCoO₂ (HT-LCO). To form a robust and well-functioning device structure, the stress in the individual layers of the device stack and adhesion (between layers and with the substrate) can be controlled and optimized, especially as the positive electrode undergoes this relatively high temperature (within a range of 500° C. to 800° C., for example) thermal treatment.

In addition, there is a need to improve the device metrics of which energy density is one of the key metrics. In order to increase the energy density and further improve the form factor of thin film solid state batteries, use of thinner substrates is one of the most effective and necessary methods. However, use of thinner (10 microns to 100 microns thick, for example) substrates brings many challenges related to making devices with satisfactory operational characteristics and robustness. One of the key issues that the present inventors have observed is the poor adhesion of layers in the device stack and between stack and substrate when the device on a thin substrate is subjected to annealing as needed for proper formation of the cathode—a layer of LCO—for example. Another issue due to the use of thin substrates, which are quite flexible when handled, is that device layers, if adhesion is poor between layers or between layers and the substrate, can crack and even delaminate during the various stages of device fabrication. This cracking and delamination may be observed visually from the top side of the device, and for transparent substrates through the backside of the substrate—as discussed in more detail below. Furthermore, the cracking and delamination may reduce mechanical yield of TFBs at the end of the fabrication due to further build-up of stress with additional layers after LCO deposition and anneal. Such a build-up of stress during the fabrication step without good adhesion of the device to the substrate will create an even worse situation when the device is cycled, wherein volume changes occur in the device with Li moving back and forth between cathode and anode. Herein “mechanical yield” refers to the electrochemical cell's mechanical stability on completion of fabrication, and after minimal cycling.

Furthermore, another key issue that the present inventors have observed is the intermixing of the cathode layer (LiCoO₂) and the CCC layers during the LCO thermal annealing which can lead to higher resistance of the current collectors and loss of the active material (LiCoO₂), in which the severity of the intermixing is dependent on the substrate material, the LiCoO₂ deposition process and the annealing temperature. The intermixing of the LiCoO₂ layer could lead to: poorer adhesion of the structure/CCC to the substrate; impurity in the LCO layer and loss of the active material; not to mention the stress at the location of the intermixing, dependent on the severity. This intermixing may be observed visually through the backside of an optically transparent/translucent substrate—as discussed in more detail below—and results in deterioration of device performance, due to increased resistance of the CCC (due to LCO in the CCC) and/or reduced effectiveness of the positive electrode (due to CCC material in the positive electrode), which is measurable during battery cell cycling tests as lower battery cell capacity utilization, higher IR drop, etc. Furthermore, the intermixing may reduce mechanical yield of TFBs and be manifest in wafer/substrate curvature.

One example of such a thin substrate is a mica substrate, a kind of silicate (phyllosilicate) mineral that has a layered or platy structure and can readily be divided into very thin layers—125 to 25 microns or thinner, down to 10 microns. Mica is chemically inert, elastic, flexible, and electrically insulating. It is a good substrate to use for thin film batteries, unless high temperature processing above about 500° C. to 600° C. is needed, at which temperatures the inventors have observed a tendency for peeling and delamination of device layers from the substrate. This limits the use of mica substrates for making high quality batteries because the annealing temperature of typical cathode materials—such as LCO—may need to be greater than 600° C., in order to obtain cathode material with purer phase and greater crystallinity (greater than 90% HT-LCO) and good battery performance. This is especially true if the LCO deposition rate is very high for cost of ownership reduction.

Another example of a thin substrate is a polycrystalline ceramic substrate such as yttrium oxide-stabilized zirconium oxide (YSZ). While these YSZ substrates can withstand much higher thermal budgets than mica for example, including annealing beyond 600° C. to form a higher quality LCO with purer phase and greater crystallinity (greater than 90% HT-LiCO, by weight or by volume), the present inventors found that adhesion between the substrate and the device stack layers may also be less than satisfactory, leading to mechanical stability issues. Furthermore, the present inventors found that the intermixing of the CCC layers and the LiCoO₂ layer during the LCO annealing process is quite significant leading to device stability and performance issues, as indicated above.

Another example of a thin substrate is a glass substrate with a relatively high glass transition temperature—greater than the annealing temperature, for example and in some embodiments greater than 700° C. Examples of such glasses include aluminoborosilicate glass with a glass transition temperature of 717° C., and an alkaline earth boro-aluminosilicate with a glass transition temperature of approximately 700° C. On these substrates, the inventors found that adhesion between the substrate and the device stack layers may also be less than satisfactory, leading to device performance and mechanical stability issues.

Clearly, there is a need for fabrication processes and solid state thin film battery structures that reduce cracking, delamination and intermixing of device layers during high temperature annealing (such as an LCO anneal) and thus maintain: the function (adhesion and conductance) of the CCC; purity, phase and effective mass of the cathode layer, the function and integrity of the whole solid state thin film battery structure (avoiding delamination of device layers by controlling stress between device layers and/or the stack of device layers and the substrate). Furthermore, there is a need for fabrication processes and solid state thin film battery structures that reduce cracking and delamination of device layers during high temperature annealing (such as an LCO anneal) and thus permit faster deposition rate processes for device materials such as LCO which typically needs higher annealing temperature to form desirable layer qualities than for low deposition rate processes, thus permitting higher throughput and lower cost of ownership.

Furthermore, the performance of these thin film batteries is dependent on the ease of lithium transport through the layers of the stack, which is influenced not only by the impedance of each layer but also by the resistance/impedance at the interfaces between layers. As such, large charge transfer resistance at theses electrode/electrolyte interfaces in solid state thin film batteries has (or can have) a big impact on the overall lithium transport and therefore the battery performance, where some of the performance factors would be power capability and capacity utilization.

Clearly, there is a need for device structures and methods of manufacture that effectively reduce the interfacial resistance in these solid state thin film batteries in order to promote lithium transport through the interfaces.

### SUMMARY

According to some embodiments, a solid state thin film battery may comprise: an adhesion promotion and intermixing barrier layer on a substrate with a substrate thickness in the range of 10 microns to 1,000 microns, the adhesion promotion and intermixing barrier layer comprising an electrically insulating material, the adhesion promotion and intermixing barrier layer having a thickness in the range of 50 nm to 5,000 nm; a metal adhesion layer on the adhesion promotion and intermixing barrier layer; a current collector layer on the metal adhesion layer; a cathode layer on the current collector layer, an electrolyte layer on the cathode layer; and an anode layer on the electrolyte layer; wherein the adhesion promotion and intermixing barrier layer, the metal adhesion layer, the current collector, the cathode layer, the electrolyte layer and the anode layer form a stack on the thin substrate.

According to some embodiments, a method for manufacturing solid state thin film batteries may comprise: depositing an adhesion promotion and intermixing barrier layer on a substrate with a substrate thickness in the range of 10 microns to 1,000 microns, the adhesion promotion and intermixing barrier layer comprising an electrically insulating material, the adhesion promotion and intermixing barrier layer having a thickness in the range of 50 nm to 5,000 nm; depositing a metal adhesion layer on the adhesion promotion and intermixing barrier layer, depositing a current collector layer on the metal adhesion layer; depositing a cathode layer on the current collector layer, annealing the cathode layer, at a temperature in the range of 500° C. to 800° C.; after the annealing, depositing an electrolyte layer on the cathode layer; and depositing an anode layer on the electrolyte layer; wherein the adhesion promotion and intermixing barrier layer, the metal adhesion layer, the current collector layer, the cathode layer, the electrolyte layer and the anode layer form a stack on the thin substrate.

According to some embodiments, an apparatus for manufacturing solid state thin film batteries may comprise: a first system for depositing an adhesion promotion and intermixing barrier layer on a substrate with a substrate thickness in the range of 10 microns to 1,000 microns, the adhesion promotion and intermixing barrier layer comprising an electrically insulating material, the adhesion promotion and intermixing barrier layer having a thickness in the range of 50 nm to 5,000 nm; a second system for depositing a metal adhesion layer on the adhesion promotion and intermixing barrier layer and a current collector layer on the metal adhesion layer, a third system for depositing a cathode layer on the current collector layer; a fourth system for annealing cathode layer, at a temperature in the range of 500° C. to 800° C.; a fifth system for depositing an electrolyte layer on the cathode layer, and a sixth system for depositing an anode layer on the electrolyte layer, wherein the adhesion promotion and intermixing barrier layer, the metal adhesion layer, the current collector layer, the cathode layer, the electrolyte layer and the anode layer form a stack on the thin substrate.

### BRIEF DESCRIPTION OF THE DRAWINGS

These and other aspects and features of the present disclosure will become apparent to those ordinarily skilled in the art upon review of the following description of specific embodiments in conjunction with the accompanying figures, wherein:

FIG. 1 is a cross-sectional representation of a thin film battery (TFB) including an intermixing barrier/adhesion promotion layer between the substrate and adhesion and current collector layers, according to some embodiments;

FIG. 2 is a cross-sectional representation of a TFB as in FIG. 1 further including an interlayer for reducing the resistance and over-potential at the interfaces with an electrode and a solid state electrolyte, according to some embodiments;

FIG. 3 is a cross-sectional representation of a double-sided TFB including an intermixing barrier/adhesion promotion layer between the substrate and adhesion and current collector layers, and an interlayer for reducing the resistance and over-potential at the interfaces with an electrode and a solid state electrolyte, according to some embodiments;

FIG. 4 is a cross-sectional representation of a double-sided thin film battery as in FIG. 1, except for being optimized for serial connection of the TFBs, according to some embodiments;

FIG. 5 is a schematic illustration of a cluster tool for TFB fabrication, according to some embodiments;

FIG. 6 is a representation of a TFB fabrication system with multiple in-line tools, according to some embodiments; and

FIG. 7 is a representation of an in-line tool of FIG. 5, according to some embodiments.

### DETAILED DESCRIPTION

Embodiments of the present disclosure will now be described in detail with reference to the drawings, which are provided as illustrative examples of the disclosure so as to enable those skilled in the art to practice the disclosure. Notably, the figures and examples below are not meant to limit the scope of the present disclosure to a single embodiment, but other embodiments are possible by way of interchange of some or all of the described or illustrated elements. Moreover, where certain elements of the present disclosure can be partially or fully implemented using known components, only those portions of such known components that are necessary for an understanding of the present disclosure will be described, and detailed descriptions of other portions of such known components will be omitted so as not to obscure the disclosure. In the present specification, an embodiment showing a singular component should not be considered limiting; rather, the disclosure is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

The present disclosure describes how an adhesion promotion and intermixing barrier layer is added to the top surface of a TFB substrate prior to depositing the layers of the device on the substrate. Furthermore, the present disclosure describes the addition of an interlayer for reducing the resistance and over-potential at the interfaces with an electrode and a solid state electrolyte. As described below, in some embodiments the addition of these extra layers enables fabrication of TFBs (single-sided and double-sided) on thinner substrates to make higher energy density devices.

The adhesion promotion and intermixing barrier layer is characterized as having good adhesion to both the substrate and the current collector (both ADL and current collector), acting as a double-sided glue layer and reducing the interdependence of the CCC adhesion layer and the substrate. This increases the freedom in material selection of TFB substrates, and facilitates increase of the energy density of TFB devices. Furthermore, the adhesion promotion and intermixing barrier layer is also characterized as inhibiting intermixing of device layers—such as current collector and LCO cathode—during annealing of the cathode.

The adhesion promotion and intermixing barrier layer may be a thin, electrically insulating (with a resistance greater than 30 MΩ, for example) dielectric layer (e.g., Al₂O₃, ZrO₂, SiO₂, Si₃N₄, etc., including suboxides, stoichiometric and nonstoichiometric variations, and crystalline, amorphous and mixed phase versions of the same), which is able to withstand high annealing temperature and provide better adhesion and stress balance. The adhesion promotion and intermixing barrier layer is deposited between a substrate (e.g., silicon, mica, YSZ, and glass) and the current collector layers, the latter including a metal adhesion layer (ADL) and a metal, typically refractory, current collector. The adhesion promotion and intermixing barrier layer should have good thermal stability at temperatures higher than 700° C. and promote improved adhesion to both the substrate (silicon, mica, YSZ, and glass) and most of the current collector metal adhesion layers (e.g., Ti, Ta, TaN, etc.). The thickness of the dielectric adhesion promotion and intermixing barrier layer is in the range from 50 nm to 5000 nm, in embodiments in the range from 50 nm to 500 nm, and in embodiments in the range from 100 nm to 300 nm.

Furthermore, the present disclosure describes electrochemical device structures and methods of fabricating the electrochemical devices including one or more thin interlayers between an electrode (positive and/or negative) and the solid state electrolyte (LiPON, for example), for reducing the resistance and over-potential at the interfaces with the electrode and the solid state electrolyte. Furthermore, the device may include an interlayer comprising a multiplicity of layers of different materials between an electrode and the electrolyte in order to create a “cascading” chemical potential through the interlayer.

The materials of the interlayer can be selected from metal oxides such as titania, tantalum oxide, zirconia, zinc oxide, tin oxide, and alumina (including suboxides, stoichiometric and nonstoichiometric variations, and crystalline, amorphous and mixed phase versions of the same) and including cathodically active battery materials (e.g. materials with a lower chemical potential than the cathode) such as titania, TiS₂, etc. (including suboxides, stoichiometric and nonstoichiometric variations, and crystalline, amorphous and mixed phase versions of the same), where the interlayer materials satisfy the following criteria:

1) the interlayer material does not affect Li intercalation/de-intercalation at either interface;

2) the interlayer material reduces resistance and overpotential at interfaces between the interlayer and both the electrode layer and the electrolyte layer;

3) for an interlayer between a lithium-containing cathode layer and an electrolyte layer, the electromotive force of the interlayer material compared with lithium metal is lower than the emf of the host cathode material versus lithium metal;

4) for an interlayer between an anode layer and an electrolyte layer, the electromotive force of the interlayer material compared with lithium metal is lower than the emf of the host anode material versus lithium metal; and

5) the interlayer material as deposited is an ion conductor, such as a lithium ion conductor, and is generally an electron conductor, although in embodiments the interlayer may be electrically non-conductive when thin enough for electron tunneling.

The thickness of the interlayer in embodiments may be in the range of 2 nm-200 nm, and in some embodiments the thickness may be in the range of 10 nm-50 nm.

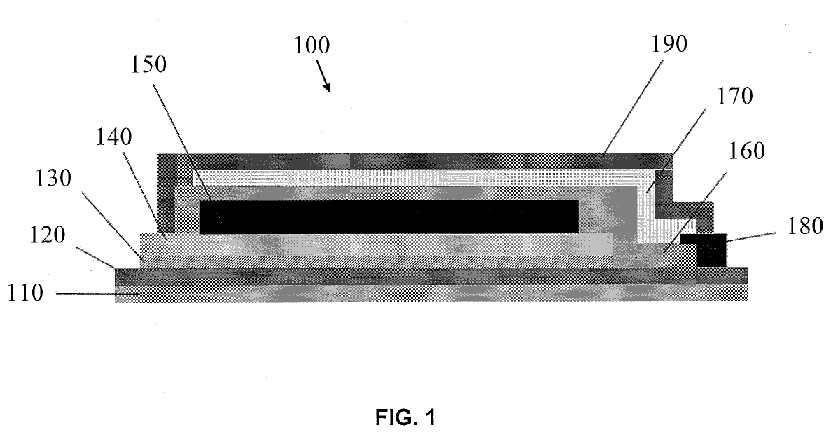

FIG. 1 shows an example of a solid state TFB device 100 according to some embodiments comprising: a substrate 110 (such as silicon, mica, YSZ ceramic, with 2 to 8 weight percent yttrium oxide and other minor additives and impurities, and glass), an adhesion promotion and intermixing barrier layer 120 over the top substrate surface, a metal adhesion layer 130 (e.g. Ti) and cathode current collector (CCC) 140 (e.g. Au, Pt) on the top surface of the intermixing barrier layer, a cathode 150 (a layer of LCO, for example) on the CCC, an electrolyte 160 covering the cathode and portions of the CCC, isolating the CCC from any other electrodes, an anode 170 (e.g. Li) on portions of the top surface of the electrolyte and the anode current collector (ACC) 180 (e.g. Au), and encapsulation layer(s) 190 covering the exposed surfaces of the anode and electrolyte and portions of the current collectors. It is noted that the adhesion layer 130 is also provided between the adhesion promotion and intermixing barrier layer and the ACC if needed, but may not be needed in all embodiments.

Silicon substrates may be single crystal, polycrystalline or microcrystalline, and may have an oxide layer on the surfaces typically between 0.5 nm and 2 microns in thickness, including native oxides and thermally grown or deposited oxides. Silicon substrates of thickness ranging between 10 microns and 1,000 microns may be used.

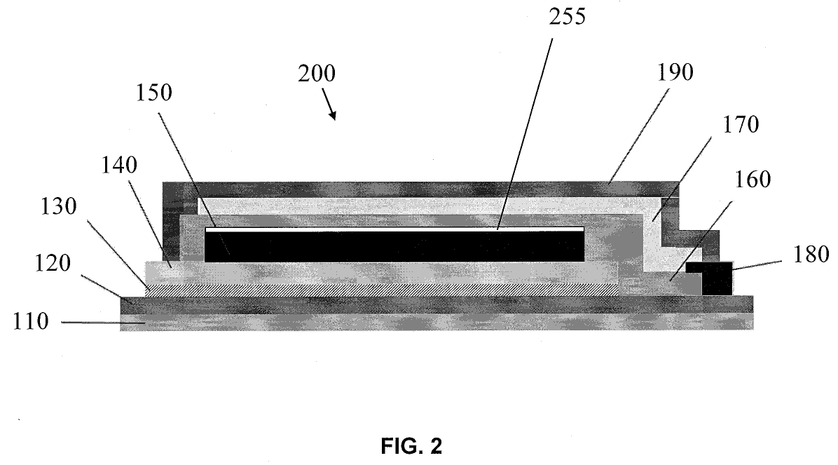

FIG. 2 shows an example of a solid state TFB device 200 according to some embodiments comprising a device such as described above with reference to FIG. 1 with an interlayer 255 (a layer of titania and/or alumina, for example, including suboxides, stoichiometric and nonstoichiometric variations, and crystalline, amorphous and mixed phase versions of the same) at the interface between the cathode layer 150 and electrolyte layer 160.

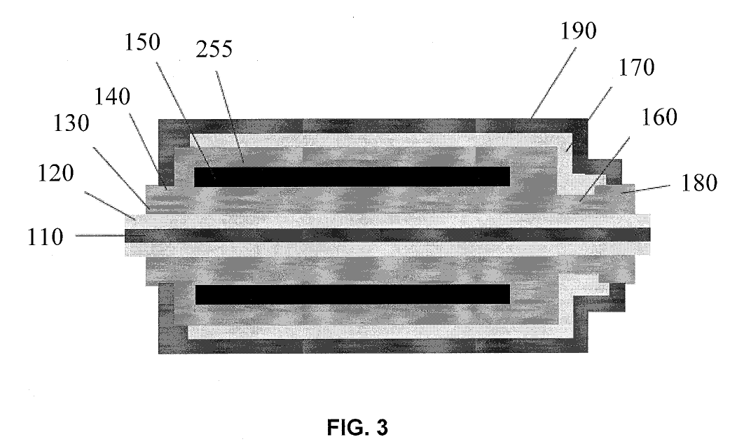

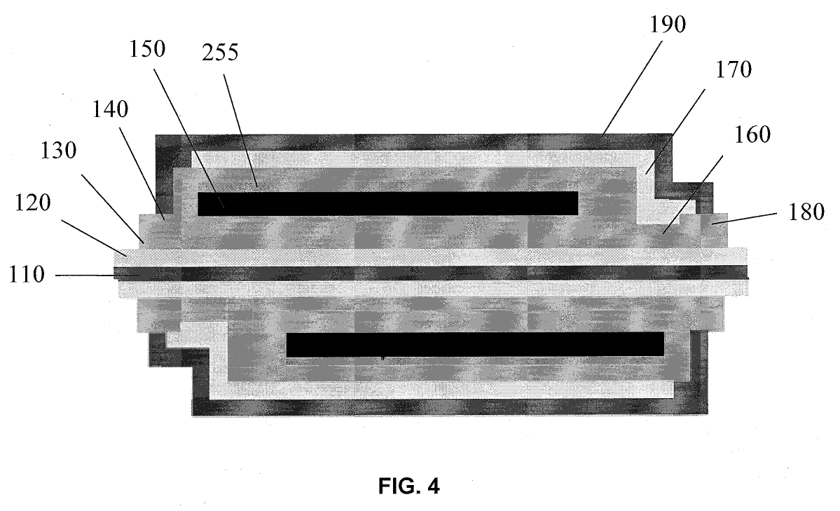

FIGS. 3 & 4 show examples of double-sided solid state TFB devices according to some embodiments. Furthermore, it is noted that the configuration of the cells in FIG. 3 is most suitable for parallel connection of the cell on one side with the cell on the other side of the substrate. If it is desired to connect the cells in series, then the configuration shown in FIG. 4 is most suitable.

An example of the TFB device of FIG. 1 is described in more detail, as follows. The TFB of FIG. 1 would ordinarily be fabricated using shadow masks, and is described as such below, although it is appreciated by persons of ordinary skill in the art that a maskless fabrication process may be used to fabricate TFBs with the same materials and order of layers in the device stack, just with a slightly different layout. The substrate, for example a glass, ceramic, mica, metal or silicon substrate may have a thickness within the range from 10 μm to 1,000 μm, in embodiments within the range of 10 μm to 700 μm, and in further embodiments in the range of 10 μm to 100 μm. The layers deposited on the substrate are described next. The adhesion promotion and intermixing barrier layer, may comprise one or more of Al₂O₃, ZrO₂, SiO₂, Si₃N₄, etc., (including suboxides, stoichiometric and nonstoichiometric variations, and crystalline, amorphous and mixed phase versions of the same) with a thickness in the range of 50 nm to 5000 nm, in embodiments in the range of 50 nm to 500 nm, and in embodiments in the range of 100 nm to 300 nm, deposited on the surface of the thin substrate. A metal adhesion layer (e.g., Ti, Ta, TaN) with an area larger than that of the cathode layer with thickness ranging from 10 nm to 1000 nm is deposited on the adhesion promotion and intermixing barrier layer. A cathode current collector (e.g., Au, Pt) with an area the same as the adhesion layer with thickness ranging from 50 nm to 1000 nm is deposited on top of the metal adhesion layer. A cathode layer (e.g., LiCoO₂) with thickness ranging from 0.5 μm to 40 μm is deposited on top of the cathode current collector layer. The stack is thermally treated to anneal the cathode layer, as needed, before further deposition steps. A solid state electrolyte layer (e.g., LiPON) having a larger area than and extending beyond the cathode and the cathode current collector (except for the electrical contact area, where the CCC is left uncovered) with thickness ranging from 0.5 μm to 4 μm is deposited on top of the cathode layer. An anode current collector (e.g., Cu, Au, Pt, or combination thereof) with no overlap with the cathode layer and the cathode current collector and with thickness ranging from 100 nm to 1000 nm is deposited on top of the solid state electrolyte; additionally, a metal adhesion layer may be deposited before the anode current collector, if needed, in a manner similar to that used for the cathode current collector layer. An anode (e.g., Li metal) with an area larger than that of the cathode and smaller than that of the electrolyte layer and with thickness ranging from 1 Jim to 15 μm, overlapping partially with the anode current collector layer, is deposited on the electrolyte and a portion of the ACC. An encapsulation layer of varying functions with an area larger than that of the anode layer and smaller than that of the electrolyte layer, with thickness ranging from 400 nm to 3 μm is deposited on top of the anode layer; the encapsulation layer can be a combination of a metal layer (e.g. Cu, Au, Pt, etc.) and a dielectric layer (such as LiPON, Al₂O₃, ZrO₂, SiO₂, Si₃N₄, planarizing polymer layers, etc., where the planarizing polymer layers may be one or more of parylene, silicone and photoresist, for example). Furthermore, when an interlayer is included, the interlayer (e.g., titania and/or alumina, including suboxides, stoichiometric and nonstoichiometric variations, and crystalline, amorphous and mixed phase versions of the same) with an area the same as that of the cathode layer and thickness ranging from 2 nm to 50 nm is deposited on top of the cathode layer, followed by the electrolyte layer being deposited on the interlayer.

In double-sided solid state TFB embodiments, the layers are deposited on both sides of the substrate, and the depositions may in embodiments be done on both sides at once, or in embodiments one layer at a time, first on one side and then on the other. Note that in some embodiments of the double-sided solid state TFB the substrate barrier layer may be deposited on both sides of the substrate prior to depositing device layers on both sides of the substrate, and in other embodiments, a substrate barrier layer may be deposited on only one of the substrate surfaces prior to depositing device layers on both sides of the substrate.

The adhesion promotion and intermixing barrier layer of FIG. 1 is incorporated in embodiments into the device stack to overcome problems due to cracking and even delamination from the substrate of device layers, as described in more detail below. To achieve good adhesion of the stack of device layers to the substrate, managing the following is advantageous: (1) good adhesion strength between each interface from chemical bonding and/or mechanical (roughness) bonding, (2) built-in stress within each layer designed to cancel out stress between and built-in to other layers in the stack, and (3) stress due to thermal annealing as may be needed to achieve desirable cathode material properties. As such, addition of an Al₂O₃ adhesion promotion and intermixing barrier layer promotes better adhesion between the YSZ and adhesion promotion and intermixing barrier layer and between the adhesion promotion and intermixing barrier layer and the Ti/Pt (ADL/current collector) than observed for YSZ and Ti/Pt (ADL/current collector) deposited directly on an YSZ substrate without an Al₂O₃ adhesion promotion and intermixing barrier layer. This may be due to the action of the Ar/O₂ plasma, specifically the O₂ content, generated during deposition by PVD of the Al₂O₃ layer, inducing a better chemical bonding at the YSZ-Al₂O₃ interface. In addition, the deposition of the Ti ADL on Al₂O₃ may result in the formation of Ti—O bonds with the O in Al₂O₃ which may be stronger than the Ti—O bonds with the O in YSZ. It is also possible that the stress in the Al₂O₃ layer itself may compensate the stress built up in the device stack (up to the full stack formation) and/or substrate during processing, particularly considering the stress that may be built up in the device during annealing of the cathode material due to the different thermal expansion coefficients (TEC) of the different device layers and the substrate.

Deposition of alumina films optimized for use to promote adhesion and/or intermixing may be achieved using PVD at higher areal power densities (greater than 3.5 KW/cm², for example) in an argon/oxygen gas plasma environment. Furthermore, higher deposition power may induce better adhesion per the logic of the previous paragraph.

Furthermore, the adhesion promotion and intermixing barrier layer of FIG. 1 is incorporated in embodiments into the device stack to overcome problems due to intermixing of the adhesion layer and current collector layers with the LCO cathode observed in devices without the adhesion promotion and intermixing barrier layer as described in more detail below. It is conjectured that the root cause of the intermixing during LCO annealing is that the thin flexible substrate sheets (e.g., YSZ ceramic) with thickness in the range of 10 microns to 100 microns, and in embodiments 20 microns to 40 microns, may have a rougher surface (as compared to smoother glass and mica substrates), which may result in rougher (surface roughness is characterized by Rms=32.2 nm measured over a 5 m×5 m area in a first example and by Rms=28.5 nm over a 5 micron×5 micron area in a second example, where Rms is the root mean square surface roughness measured by calculating the root mean square of the surface peaks and valleys), more porous, and varying thicknesses of the current collector layers that are built on top of it—i.e., lower thickness in the “valleys” of the rougher surface. In addition, the Zr ion packing density in the ZrO₂ unit cell with a fluorite structure is 58.8%, indicating a porous lattice structure. Thus, during the cathode (e.g., LiCoO₂) deposition with PVD sputtering, there may be plasma damage on the porous and thinner regions of the CCC films, resulting in initial penetration of the CCC by the LiCoO₂ layer and intermixing of LCO with the CCC materials. Such a situation is expected to be further aggravated during the post-deposition, high temperature annealing of the cathode material, thus leading to the observed intermixing phenomena.

Given such a hypothesis, the present disclosure provides that the substrate surface is modified by the addition of a layer with a high ion packing density, which creates a smoother surface and/or less porous layer, over which a smooth and dense CCC layer (CCC with a smooth surface and/or less porous layer) may be formed and at the same time exhibit better adhesion properties between the substrate and the CCC, bi-directionally. Herein “bi-directionally” is used to mean that adhesion promotion occurs at both interfaces—the substrate/adhesion promotion and intermixing barrier layer interface and the adhesion promotion and intermixing barrier layer/metal adhesion layer interface. In addition, the adhesion promotion and intermixing barrier layer may in embodiments function to limit interdiffusion of atoms/ions between the substrate and the CCC layer.

In embodiments a thin, dense and electrically insulating (with a resistance greater than 30 MΩ, for example) adhesion promotion and intermixing barrier layer (e.g., Al₂O₃ with a 65.6% ion packing density) is deposited between the substrate and the adhesion and current collector layers. Deposition of a 200 nm thick alumina film can reduce the surface roughness of a YSZ substrate in a first example from Rms=32.2 nm over a 5 micron×5 micron area to Rms=28.2 over a 5 micron×5 micron area, and in a second example from Rms=28.5 nm over a 5 micron×5 micron area to Rms=26.6 over a 5 micron×5 micron area, Deposition of alumina films optimized for intermixing prevention with smoother surfaces and/or less porous bulk may be achieved using physical vapor deposition (PVD) at higher areal power densities (greater than 3.5 W/cm², for example) in an argon/oxygen gas plasma environment, for example. It is expected that alumina with composition AlOₓ where x is in the range of 1.2 to 1.5 may have the desired properties for some embodiments. The intermixing barrier layer could be Al₂O₃, Si₃N₄ and other electrically insulating layers (including suboxides, stoichiometric and nonstoichiometric variations, and crystalline, amorphous and mixed phase versions of the same) with higher cation packing density than Zr ions in the ZrO₂ unit cell of the YSZ substrate and stability (maintains mechanical strength, stable chemical composition, for example) at temperatures in excess of 700° C. The thickness of the intermixing barrier layer is in the range of 50 nm to 5000 nm, in embodiments in the range of 50 nm to 500 nm, and in embodiments in the range of 100 nm to 300 nm.

Furthermore, even though the adhesion promotion and intermixing barrier layer has been demonstrated to be effective at stopping intermixing of CCC and cathode layers it should be noted that the adhesion promotion and intermixing barrier layer may be effective in stopping intermixing of all layers in the solid state TFB stack.

To demonstrate the efficacy of the adhesion promotion and intermixing barrier layer on a silicon substrate, the following experiments were conducted. As a control, the following stack (without an adhesion promotion and intermixing barrier layer) was fabricated: on a silicon substrate (0.76 mm thick Si(100) wafers) with one micron of thermal oxide, a Ti/Au metal adhesion layer/CCC, followed by an LCO cathode, a LiPON electrolyte and a Li anode layer. The stack was annealed at 650° C. after LCO deposition (to improve LCO layer properties) and before LiPON deposition, and after Li anode layer deposition lower impedance was measured across the stack than needed for a functional device (leakage current and lower device voltage were observed—the electrical leakage was between the ACC and CCC through the substrate, with the resistance between CCC and ACC being only a few to several M Ohms). A second stack was fabricated: on a silicon substrate (0.76 mm thick Si(100) wafers) with one micron of thermal oxide coated with a 150 nm silicon nitride adhesion promotion and intermixing barrier layer, according to some embodiments, a Ti/Au metal adhesion layer/CCC, followed by an LCO cathode, a LiPON electrolyte and a Li anode layer. The stack was annealed at 650° C. after LCO deposition and after Li anode layer deposition a much higher impedance was measured across the stack than for the control. Note that the electrical resistance of the device for a 3 micron thick LiPON layer of 1 cm² area should be at least 3E9 Ohms, where the electrical resistivity of LiPON is greater than 1E13 Ohm-cm. In the case of the control stack the silicon substrate has only SiO₂ as the electrically isolating layer between the CCC and ACC, whereas there are both SiO₂ and Si₃N₄ layers for the stack with the adhesion promotion and intermixing barrier layer. This implies that the substrates with SiO₂ only may undergo intermixing (LCO through the CCC) which creates internal shorting paths between the CCC and the ACC through the SiO₂ coating of the silicon substrate and the semiconducting substrate itself, which is most likely occurring during the high temperature anneal step.

To demonstrate the efficacy of the adhesion promotion and intermixing barrier layer on a mica substrate, the following experiments were conducted. As a control, the following stack (without an adhesion promotion and intermixing barrier layer) was fabricated: on a mica substrate a Ti/Au metal adhesion layer/CCC, followed by an LCO cathode, a LiPON electrolyte and a Li anode layer. The stack was annealed at 600° C. after LCO deposition and before LiPON deposition, and after Li anode layer deposition the stack showed poor adhesion to the mica substrate, resulting in significant delamination of the stack from the substrate. A second stack was fabricated: on a mica substrate coated with an alumina adhesion promotion and intermixing barrier layer, according to some embodiments, a Ti/Au metal adhesion layer/CCC, followed by an LCO cathode, a LiPON electrolyte and a Li anode layer. The stack was annealed at 600° C. after LCO deposition and after Li anode layer deposition the stack showed better adhesion to the mica substrate than for the control. It was noted that the cracking and delamination was most evident after the Li anode deposition, due to defects being more readily visible after lithium deposition and also potentially due to a further build-up of stress with the lithium metal deposition which could lead to more cracking and delamination.

Furthermore, even better results were seen on both YSZ, with 2 to 8 weight percent yttrium oxide, and glass (an alkaline earth boro-aluminosilicate with glass transition temperature of approximately 700° C.) substrates, for which the addition of an adhesion promotion and intermixing barrier layer appears to have eliminated all delamination—providing a 100% mechanical yield of TFB cells. The addition of the adhesion promotion and intermixing barrier layer has been found to improve the mechanical yield of TFBs fabricated on all substrates tested by the inventors, including mica, YSZ and glass.

To demonstrate the efficacy of the intermixing barrier aspect of an adhesion promotion and intermixing barrier layer on a YSZ substrate, the following experiments were conducted. As a control a stack was fabricated: adhesion layer/CCC (Ti/Au) and LCO layers were deposited on a YSZ substrate (the substrate was without an adhesion promotion and intermixing barrier layer). The stack was annealed at 650° C. and intermixing of the LCO and CCC layers was observed through the transparent substrate—clearly seen as a darkening of the stack. A second stack was fabricated: adhesion/CCC (Ti/Au) and LCO layers on a YSZ substrate coated with an alumina adhesion promotion and intermixing barrier layer. The stack was annealed at 650° C. and no intermixing of the LCO and CCC layers was observed through the transparent substrate—there was no discoloration or signs of delamination of the layers. The YSZ substrate with alumina adhesion promotion and intermixing barrier layer does not show discoloration, while the YSZ substrate without the adhesion promotion and intermixing barrier layer does show discoloration (the gold color of the CCC is severely disrupted by black (LCO) material), demonstrating the effectiveness of the alumina adhesion promotion and intermixing barrier layer for preventing intermixing of layers of the stack deposited on the surface of the YSZ substrate. The addition of the alumina adhesion promotion and intermixing barrier layer on the YSZ substrate effectively prevents intermixing of the LCO cathode material and the gold current collector during annealing of the LCO cathode, and therefore maintains (1) layer integrity without or with minimal intermixing, (2) good electric conductivity of the CCC layer, (3) robustness of the device architecture, and (4) phase/effective mass/composition integrity of the cathode layer. Furthermore, even though the adhesion promotion and intermixing barrier layer has been demonstrated to be effective at stopping intermixing of CCC and cathode layers it should be noted that the adhesion promotion and intermixing barrier layer may be effective in stopping intermixing of all layers in the solid state TFB stack.

While the demonstration of an adhesion promotion and intermixing barrier layer was with a PVD (physical vapor deposition) sputtered interlayer, it is expected that the concept is agnostic to the method of deposition—for example the deposition technique for the adhesion promotion layer may be any deposition technique that is capable of providing the desired composition, phase and crystallinity, and may include deposition techniques such as PVD, reactive sputtering, non-reactive sputtering, RF (radio frequency) sputtering, multi-frequency sputtering, evaporation, CVD (chemical vapor deposition), ALD (atomic layer deposition), etc. The deposition method can also be non-vacuum based, such as plasma spray, spray pyrolysis, slot die coating, screen printing, etc.

Although embodiments of the present disclosure have been particularly described with reference to planar solid state TFBs (with ACC and CCC in the same plane), the principles and teaching of the present disclosure may be applied to other solid state TFB configurations, including a vertical stack configuration where ACC and CCC are parallel, but on opposite sides of the stack.

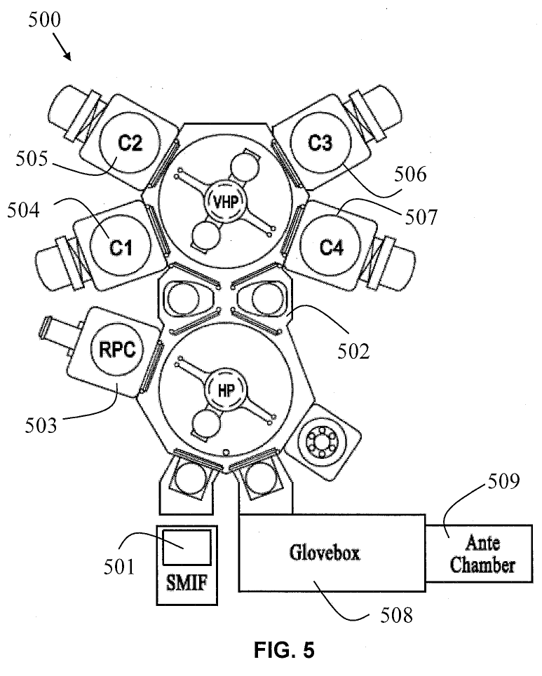

FIG. 5 is a schematic illustration of a processing system 500 for fabricating a TFB, according to some embodiments. The processing system 500 includes a standard mechanical interface (SMIF) 501 to a cluster tool 502 equipped with a reactive plasma clean (RPC) chamber 503 and process chambers C1-C4 (504, 505, 506 and 507), which may be utilized in the process steps described above. A glovebox 508 may also be attached to the cluster tool. The glovebox can store substrates in an inert environment (for example, under a noble gas such as He, Ne or Ar), which is useful after alkali metal/alkaline earth metal deposition. An ante chamber 509 to the glovebox may also be used if needed—the ante chamber is a gas exchange chamber (inert gas to air and vice versa) which allows substrates to be transferred in and out of the glovebox without contaminating the inert environment in the glovebox. (Note that a glovebox can be replaced with a dry room ambient of sufficiently low dew point as such is used by lithium foil manufacturers.) The chambers C1-C4 can be configured for process steps for manufacturing TFBs which may include, for example: deposition of an alumina adhesion promotion and intermixing barrier layer on a silicon, mica, YSZ or glass substrate, a metal adhesion layer and CCC on the adhesion promotion and intermixing barrier layer, followed by an LCO cathode on the CCC to form a stack on the substrate, annealing of the stack, etc. as described above. Examples of suitable cluster tool platforms include display cluster tools. It is to be understood that while a cluster arrangement has been shown for the processing system 500, a linear system may be utilized in which the processing chambers are arranged in a line without a transfer chamber so that the substrate continuously moves from one chamber to the next chamber.

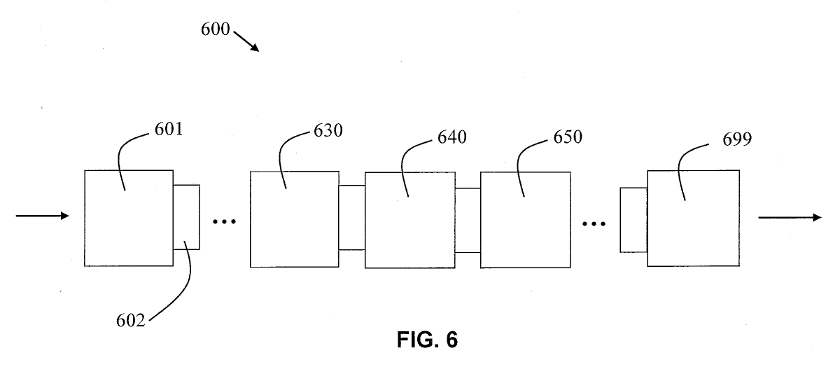

FIG. 6 shows a representation of an in-line fabrication system 600 with multiple in-line tools 601 through 699, including tools 630, 640, 650, according to some embodiments. In-line tools may include tools for depositing all the layers of a TFB. Furthermore, the in-line tools may include pre- and post-conditioning chambers. For example, tool 601 may be a pump down chamber for establishing a vacuum prior to the substrate moving through a vacuum airlock 602 into a deposition tool. Some or all of the in-line tools may be vacuum tools separated by vacuum airlocks. Note that the order of process tools and specific process tools in the process line will be determined by the particular TFB fabrication method being used, for example, as specified in the process flows described above. Furthermore, substrates may be moved through the in-line fabrication system oriented either horizontally or vertically.

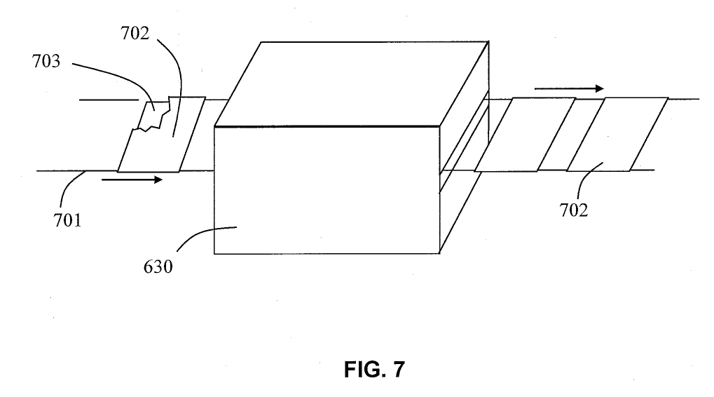

In order to illustrate the movement of a substrate through an in-line fabrication system such as shown in FIG. 6, in FIG. 7 a substrate conveyer 701 is shown with only one in-line tool 630 in place. A substrate holder 702 containing a substrate 703 (the substrate holder is shown partially cut-away so that the substrate can be seen) is mounted on the conveyer 701, or equivalent device, for moving the holder and substrate through the in-line tool 630, as indicated. An in-line platform for processing tool 630 may in some embodiments be configured for vertical substrates, and in some embodiments configured for horizontal substrates.

Some examples of apparatus for fabricating a solid state TFB according to certain embodiments are as follows. A first apparatus for manufacturing solid state TFBs according to some embodiments may include: a first system for depositing an adhesion promotion and intermixing barrier layer on a substrate with adhesion promotion and intermixing barrier layer thickness in the range of 50 nm to 5,000 nm, in embodiments in the range of 50 nm to 500 nm, and in embodiments in the range of 100 nm to 300 nm; a second system for depositing a metal adhesion layer on the adhesion promotion and intermixing barrier layer and a current collector layer on the metal adhesion layer and patterning the current collector layer to form a CCC and an ACC; a third system for depositing a cathode layer—such as an LCO layer—on the CCC layer to form a stack on the substrate; a fourth system to deposit an electrolyte layer on the cathode layer, a fifth system to deposit an anode—such as lithium metal—on the electrolyte layer to form a stack on the substrate; and a sixth system for annealing the cathode, at a temperature in the range of 500° C. to 800° C., with a soak time in the range of 4 to 15 hours, and in embodiments in the range of 2 to 30 hours, depending on the thickness of the layer to be annealed, for example; wherein the adhesion promotion and intermixing barrier layer prevents cracking and delamination of the stack of device layers during device processing, including annealing of the cathode at a temperature in the range of 500° C. to 800° C. and/or intermixing of the current collector and cathode layers during annealing of the cathode layer. Furthermore, the apparatus may include a seventh system for depositing an encapsulation layer over the stack. Furthermore, the apparatus may include an eighth system for depositing an interlayer on the cathode layer, in which case the fourth system will deposit the electrolyte layer on the interlayer. Furthermore, in some embodiments the second system may be two or more separate systems—for example, one for deposition of the metal adhesion layer, a second system for deposition of the current collector layer and a third system for patterning of the current collector layer. The apparatus may also comprise systems for patterning the various layers, and in embodiments shadow masks may be used in one or more of the aforesaid deposition systems. The systems may be cluster tools, in-line tools, stand-alone tools, or a combination of one or more of the aforesaid tools. Furthermore, the systems may include some tools which are common to one or more of the other systems.

Furthermore, a second apparatus for manufacturing solid state TFBs according to some embodiments may include: a first system for depositing adhesion promotion and intermixing barrier layer on a substrate, with adhesion promotion and intermixing barrier layer thickness in the range of in the range of 50 nm to 5,000 nm, in embodiments in the range of 50 nm to 500 nm, and in embodiments in the range of 100 nm to 300 nm; a second system for depositing a metal adhesion layer on the adhesion promotion and intermixing barrier layer and a current collector layer on the metal adhesion layer; a third system for depositing a cathode layer—such as an LCO layer—on the CCC layer, a fourth system to deposit an electrolyte layer on the cathode layer; a fifth system to deposit an anode—such as lithium metal—on the electrolyte layer, a sixth system to deposit an ACC on the anode layer to form a stack on the substrate; and a seventh system for annealing the cathode, at a temperature in the range of 500° C. to 800° C., with a soak time in the range of 4 to 15 hours, and in embodiments in the range of 2 to 30 hours, depending on the thickness of the layer to be annealed, for example; wherein the adhesion promotion and intermixing barrier layer prevents cracking and delamination of the stack of device layers during device processing, including annealing of the cathode at a temperature in the range of 500° C. to 800° C. and/or intermixing of the current collector and cathode layers during annealing of the cathode layer. Furthermore, the apparatus may include an eighth system for depositing an encapsulation layer over the stack. Furthermore, the apparatus may include a ninth system for depositing an interlayer on the cathode layer, in which case the fourth system will deposit the electrolyte layer on the interlayer. Furthermore, in some embodiments the second system may be two separate systems—one for deposition of the metal adhesion layer, and a second system for deposition of the CCC. The apparatus may also comprise systems for patterning the various layers, and in embodiments shadow masks may be used in one or more of the aforesaid deposition systems. The systems may be cluster tools, in-line tools, stand-alone tools, or a combination of one or more of the aforesaid tools. Furthermore, the systems may include some tools which are common to one or more of the other systems.

Although embodiments of the present disclosure have been particularly described with reference to TFBs with LCO cathodes, the principles and teaching of the present disclosure may be applied to TFBs with other cathode materials, including LiMO₂ (M=Co, Ni, Mn, etc.). Where, for example LiMnO₂ and LiFePO₄ may be annealed at a temperature in the range of 500° C. to 800° C., with a soak time in the range of 4 to 15 hours, and in embodiments in the range of 2 to 30 hours, depending on the thickness of the layer to be annealed, for example.

Although embodiments of the present disclosure have been particularly described with reference to TFBs, the principles and teaching of the present disclosure may be applied to other electrochemical devices, including energy storage devices generally, and also to electrochromic devices.

Although embodiments of the present disclosure have been particularly described with reference to certain embodiments thereof, it should be readily apparent to those of ordinary skill in the art that changes and modifications in the form and details may be made without departing from the spirit and scope of the disclosure.

What is claimed is:

1. A solid state thin film battery (TFB) comprising:
an adhesion promotion and intermixing barrier layer on a substrate with a substrate thickness in the range of 10 microns to 1,000 microns, said adhesion promotion and intermixing barrier layer comprising an electrically insulating material, said adhesion promotion and intermixing barrier layer having a thickness in the range of 50 nm to 5,000 nm;
a metal adhesion layer on said adhesion promotion and intermixing barrier layer;
a current collector layer on said metal adhesion layer;
a cathode layer on said current collector layer;
an electrolyte layer on said cathode layer, and
an anode layer on said electrolyte layer,
wherein said adhesion promotion and intermixing barrier layer, said metal adhesion layer, said current collector, said cathode layer, said electrolyte layer and said anode layer form a stack on said thin substrate.

2. The TFB of claim 1, wherein said adhesion promotion and intermixing barrier layer prevents cracking of said stack and delamination from said substrate of said stack during fabrication of said stack, including annealing of said cathode at a temperature in the range of 500° C. to 800° C.

3. The TFB of claim 1, wherein said adhesion promotion and intermixing barrier layer prevents intermixing of said current collector layer and said cathode layer during the annealing of said cathode layer.

4. The TFB of claim 1, wherein said intermixing barrier layer has a higher cation packing density than said thin substrate.

5. The TFB of claim 1, wherein said substrate is a silicon substrate.

6. The TFB of claim 1, wherein said substrate is a thin substrate with a substrate thickness in the range of 10 microns to 100 microns.

7. The TFB of claim 6, wherein said thin substrate is a mica substrate.

8. The TFB of claim 6, wherein said thin substrate is a yttrium oxide-stabilized zirconium oxide substrate.

9. The TFB of claim 6, wherein said thin substrate is a glass substrate, said glass substrate being formed of glass with a glass transition temperature of greater than 700° C., and wherein the annealing temperature of said cathode layer is approximately 600° C.

10. The TFB of claim 1, wherein said cathode layer is a lithium cobalt oxide (LCO) layer having greater than 90% by volume of high temperature phase LCO.

11. The TFB of claim 1, wherein said adhesion promotion and intermixing barrier layer is an alumina layer.

12. The TFB of claim 1, further comprising an interlayer between said cathode layer and said electrolyte layer, said interlayer reducing the resistance and over-potential at the interface between said cathode layer and said electrolyte layer.

13. A method for manufacturing solid state thin film batteries comprising:
depositing an adhesion promotion and intermixing barrier layer on a substrate with a substrate thickness in the range of 10 microns to 1,000 microns, said adhesion promotion and intermixing barrier layer comprising an electrically insulating material, said adhesion promotion and intermixing barrier layer having a thickness in the range of 50 nm to 5,000 nm;
depositing a metal adhesion layer on said adhesion promotion and intermixing barrier layer,
depositing a current collector layer on said metal adhesion layer,
depositing a cathode layer on said current collector layer;
annealing said cathode layer, at a temperature in the range of 500° C. to 800° C.;
after said annealing, depositing an electrolyte layer on said cathode layer; and
depositing an anode layer on said electrolyte layer;
wherein said adhesion promotion and intermixing barrier layer, said metal adhesion layer, said current collector layer, said cathode layer, said electrolyte layer and said anode layer form a stack on said thin substrate.

14. The method of claim 13, wherein said thin substrate is a silicon substrate.

15. The method of claim 13, wherein said substrate is a thin substrate with a substrate thickness in the range of 10 microns to 100 microns.

16. The method of claim 13, wherein said cathode layer is a lithium cobalt oxide (LCO) layer having greater than 90% by volume of high temperature phase LCO after said annealing.

17. The method of claim 13, wherein said adhesion promotion and intermixing barrier layer is an alumina layer.

18. The method of claim 17, wherein said alumina layer is deposited by physical vapor deposition at an areal power density greater than 3.5 W/cm² in an argon/oxygen gas plasma environment.

19. An apparatus for manufacturing solid state thin film batteries comprising:
a first system for depositing an adhesion promotion and intermixing barrier layer on a substrate with a substrate thickness in the range of 10 microns to 1,000 microns, said adhesion promotion and intermixing barrier layer comprising an electrically insulating material, said adhesion promotion and intermixing barrier layer having a thickness in the range of 50 nm to 5,000 nm;
a second system for depositing a metal adhesion layer on said adhesion promotion and intermixing barrier layer and a current collector layer on said metal adhesion layer;
a third system for depositing a cathode layer on said current collector layer;
a fourth system for annealing cathode layer, at a temperature in the range of 500° C. to 800° C.;
a fifth system for depositing an electrolyte layer on said cathode layer; and
a sixth system for depositing an anode layer on said electrolyte layer;
wherein said adhesion promotion and intermixing barrier layer, said metal adhesion layer, said current collector layer, said cathode layer, said electrolyte layer and said anode layer form a stack on said thin substrate.

20. The apparatus of claim 19, wherein said first system comprises a physical vapor deposition tool for deposition of an alumina adhesion promotion layer at an areal power density greater than 3.5 W/cm² in an argon/oxygen gas plasma environment.
